(19) United States
(12) Patent Application Publication
(10) Pub. No.: US 2019/0184933 A1
(43) Pub. Date: Jun. 20, 2019

(54) SEAT ORIENTATION AND ALERT SYSTEM AND METHOD

(71) Applicant: Honda Motor Co., Ltd., Tokyo (JP)

(72) Inventor: Stuart Masakazu YAMAMOTO, La Mirada, CA (US)

(21) Appl. No.: 15/846,375

(22) Filed: Dec. 19, 2017

(51) Int. Cl. B60R 22/48; G06T 7/70; G06K 9/00; G06K 9/62

(52) U.S. Cl. CPC B60R 22/48; G06T 7/70; G06K 9/00832; B60N 2/04; B60R 2022/4816; B60R 2022/4866; G06K 9/6202

(57) ABSTRACT

A system and method of detecting seatbelt position in a vehicle having a seat, a seatbelt assembly, and an image sensor is disclosed. The method includes determining a latch status of the seatbelt assembly, taking an image of the seat with the image sensor, determining a position of the seat from the image, and displaying the position of the seat on a display and a seatbelt unlatched warning. The seat belt latch alert system for a vehicle includes a first row of seats, a second row of seats movable between a plurality of positions, a seatbelt assembly connected to each seat having a latch configured to be latched and unlatched, an image sensor taking images of the seat if the latch is unlatched, a processor for determining a position of the seat from the image, and a display for displaying the positions of the seat and a seatbelt unlatched warning.

### TECHNICAL FIELD

The embodiments disclosed herein are directed to the field of vehicles with slidable or movable seats, particularly those in a row behind the first row of the vehicle.

### BACKGROUND

In motor vehicles equipped with slidable or movable seats, buckle switch information can be transmitted to a vehicle's control system, such as information related to whether the seat belt in a specific seat is latched or buckled and to provide a warning to the operator of the vehicle if a seat that is occupied is not latched or buckled. However, several arrangements of seats may exist within one vehicle. The vehicle must be able to distinguish and particularly identify and display the seat position when a seat belt becomes unbuckled. There is, therefore, a need for a system and method for identifying the position of the occupied seats with unbuckled seat belts accurately, and displaying the information to the operator of the vehicle.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a method of detecting seatbelt position in a vehicle having a seat, a seatbelt assembly, and an image sensor is disclosed. The method includes the steps of determining a latch status of the seatbelt assembly as being latched or unlatched, taking an image of the seat with the image sensor if the seatbelt assembly is unlatched, determining a position of the seat from the image, and displaying the position of the seat on a display and a seatbelt unlatched warning to a user.

According to another aspect, a seat belt latch alert system for a vehicle includes a first row of seats, a seat located in a second row of seats, the seat movable between a plurality of positions, a seatbelt assembly connected to the seat, the seatbelt assembly having a latch configured to be latched and unlatched, an image sensor, the image sensor taking an image of the seat if the latch is unlatched, a processor for determining a position of the seat from the image, and a display for displaying the one of the plurality of positions of the seat and a seatbelt unlatched warning to a user.

According to yet another aspect, a method of detecting seatbelt position in a vehicle having a seat, a seatbelt assembly connected to the seat, the seatbelt assembly including a webbing, an image sensor, a processor, and a display is disclosed. The method includes the steps of employing the image sensor to provide a plurality of training images of the seat in a plurality of positions in the vehicle, employing the image sensor to provide an image of a position of the seat in the vehicle, and comparing the image to the plurality of training images in the processor to identify the position of the seat in the vehicle.

### BRIEF DESCRIPTION OF THE DRAWINGS

FIG. 1 is a top view of an interior of a vehicle having a second row of seats including two standard seats and a center seat.

FIG. 2 is the top view of the interior of the vehicle with the second row of seats including two standard seats and with the center seat removed to provide access to a third row of seats.

FIG. 3 is the top view of the interior of the vehicle with each of the seats in the second row of seats moved inboard toward a longitudinal centerline of the vehicle.

FIG. 4 is the top view of the interior of the vehicle with the first seat in the second row of seats moved to an outboard position in the second row and the second seat moved inboard toward a longitudinal centerline of the vehicle and in contact the first seat.

FIG. 5 illustrates a perspective view of the second row of seats as illustrated in FIG. 2.

FIG. 6 illustrates a perspective view of a portion of an interior roof of the vehicle.

FIG. 7 is a schematic view of a seat belt latch alert system.

FIG. 8 is a cross sectional view of one of the seats taken along plane along line A-A illustrated in FIG. 5.

FIG. 9 is a schematic view of a dedicated meter in a display in the vehicle.

FIG. 10 is a schematic view of a shared display in the vehicle.

FIG. 11 is a flowchart illustrating a method detecting the position of a seat in the vehicle with an unlatched seat belt.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

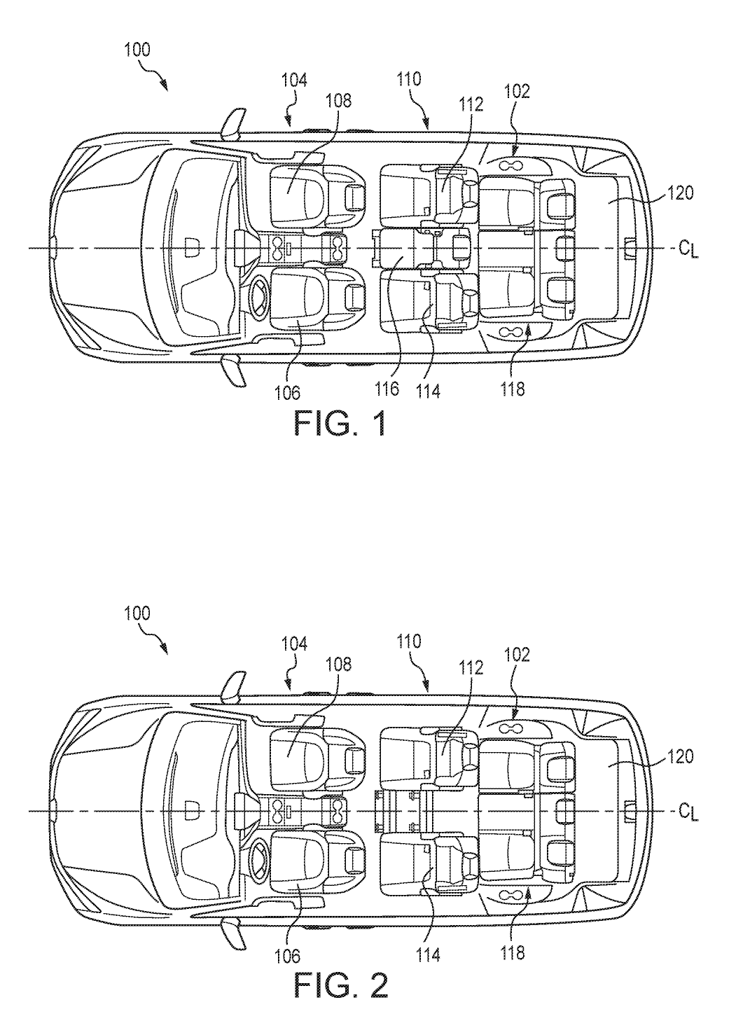

FIGS. 1-4 illustrate the interior 102 of a vehicle 100, the illustrated embodiment being a minivan. The vehicle 100 includes a first row of seats 104, which are typically the driver seat 106 and passenger seat 108, and a second row of seats 110 located behind the first row of seats 104. Each of a first seat 112 and the second seat 114 in the second row of seats 110 is movable between a plurality of positions, and a center seat 116 is removable from the vehicle 100.

In the embodiment illustrated in FIGS. 1-4, four separate arrangements of the second row of seats 110 are illustrated. FIG. 1 illustrates a super mode with the center seat 116 in place between the first seat 112 and a second seat 114, each of which is in full outboard position away from a longitudinal centerline CL of the vehicle 100.

FIG. 2 illustrates a wide mode with the first seat 112 and the second seat 114 each in full outboard position. In wide mode, the center seat 116 is removed to create a center aisle for access to a third row of seats 118, as illustrated in each of FIGS. 1-4. Alternatively, the third row of seats 118 may not be present, or the third row of seats 118 may be folded away to create a greater cargo storage area 120 behind the second row of seats 110.

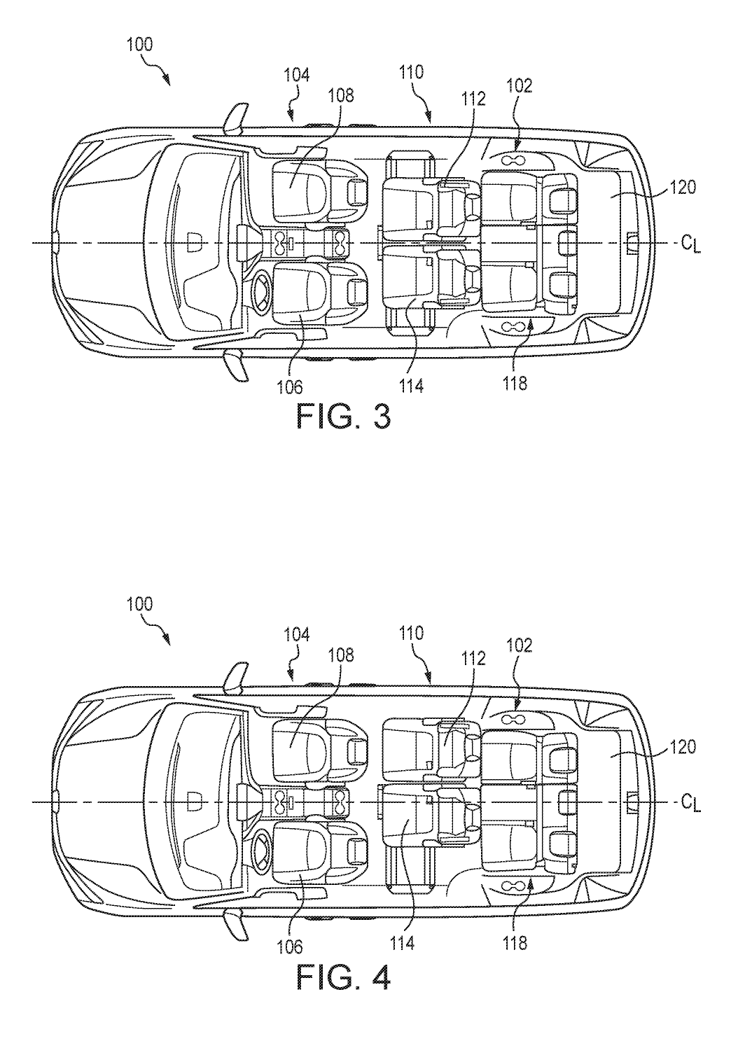

FIG. 3 illustrates a buddy mode in which the center seat 116 is removed and the first seat 112 and second seat 114 are moved inward next to each other adjacent the longitudinal centerline CL, providing easier access to the second row of seats 110 from the first row of seats 104. Such an arrangement may be preferable when small children are sitting in the second row of seats 110.

FIG. 4 illustrates an easy access mode where a first seat 112 in the second row of seats 110 is in its full outboard position, and the second seat 114 is slid inward to abut the first seat 112, providing full and easy access to the third row of seats 118, as illustrated, or to the rear cargo area 120 in alternate embodiments if the third row of seats 118 are not present or folded away. The mirror arrangement, not shown, with the second seat 114 in its full outboard position and the first seat 112 slid inward to abut the second seat 114 may also be employed with the same effects.

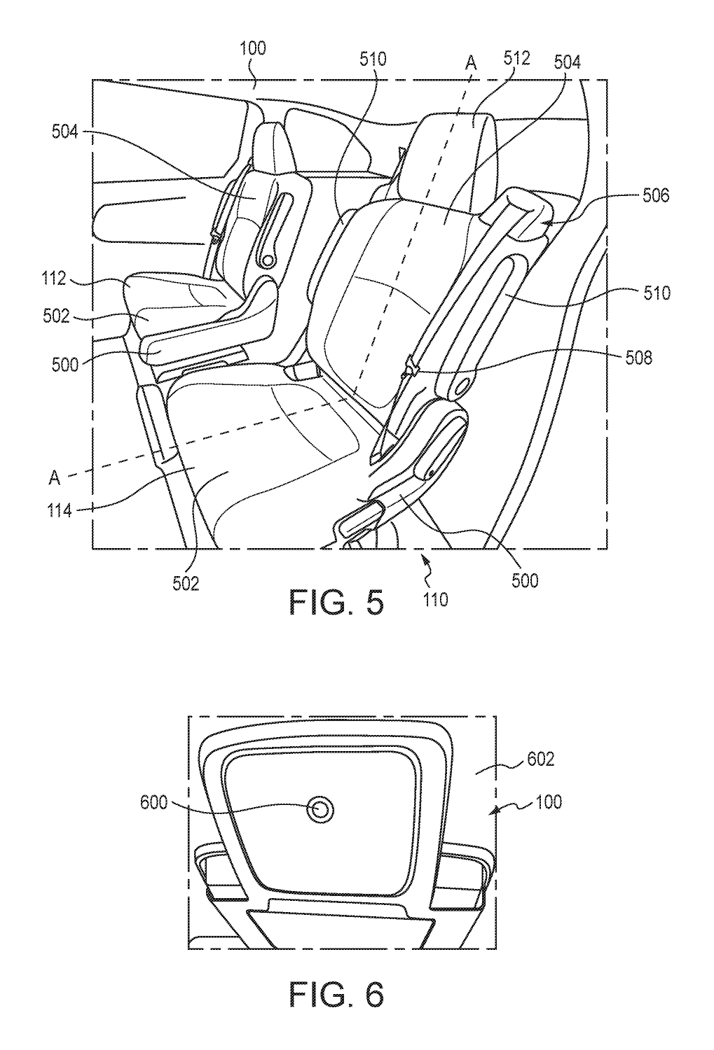

FIG. 5 illustrates the second row of seats 110 of the vehicle 100 of FIGS. 1-4. Each of the first seat 112 and second seat 114 includes a base 500, a seat cushion 502, a seat back 504, and a seatbelt assembly 506 connected to the seat back 504. The seatbelt assembly 506 includes a latch 508 configured to be latched and unlatched to allow a passenger to sit in each seat 112, 114. As illustrated in FIG. 6, an image sensor 600 may be located in the vehicle 100, such as on the ceiling 602 of the vehicle 100. The image sensor 100, which may be a camera or any other suitable sensor known to one skilled in the art, is configured to take one or more images of the seats 112, 114 if the latch 508 in either of the seats 112, 114 is unlatched. Additionally, latch 508 may further include a sensor (not shown), or the image sensor 100 may be used, to determine the latch state, latched or unlatched, of the seats 112, 114.

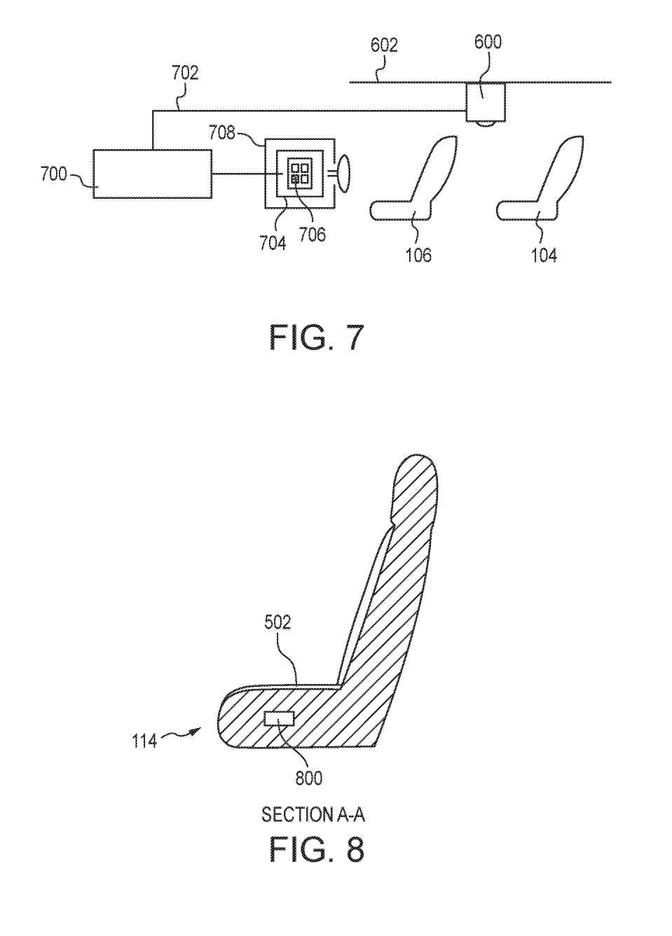

As illustrated in FIG. 7, a processor 700 is in communication with the image sensor 600. The images taken by the image sensor 600 may be transmitted via a wired connection 702, such as over a vehicle bus interface known to those skilled in the art, or via an in-vehicle wireless connection by any appropriate method known to those skilled in the art. The processor 700 is configured to determine a position of the seat 114 from the image and directs a display 704 to display a position of the seat 114 and a “seatbelt unlatched” warning 706 to a user. The processor 700 may detect one of the plurality of positions of the seat 114 based upon markers in the seat 114 from the image, such as an arm rest 510 or head rest 512 as illustrated in FIG. 5, or the processor 700 may detect the seat belt assembly 506 to identify the one of the plurality of positions of the seat 114.

As illustrated in FIG. 8, which is an illustration of a cross-section of seat 114 taken along a plane along line A-A in FIG. 5, the vehicle 100 may also include an occupancy sensor 800 in the seat cushion 502 of the seat 114 for determining if a passenger is in the seat 114. The occupancy sensor 800 may be a weight sensor, a pressure sensor, or any other suitable sensor known to those skilled in the art for determining the presence of a passenger in the seat 114. While illustrated with respect to second seat 114, each seat 106, 108, 112, 114, 116 may include an occupancy sensor 800.

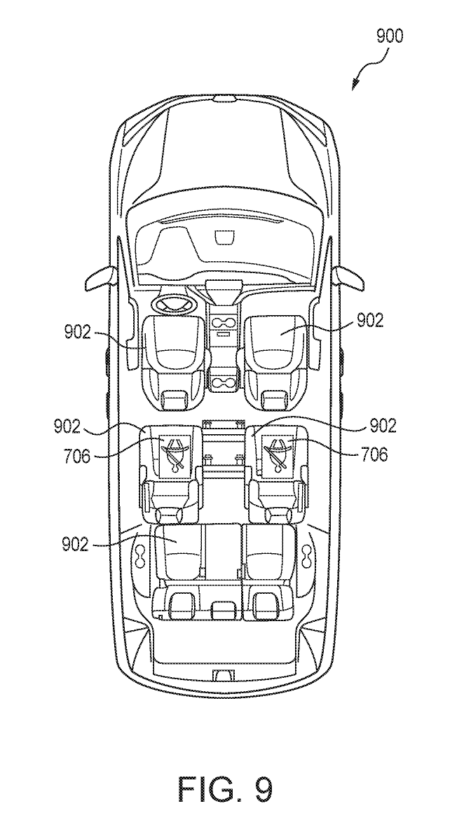

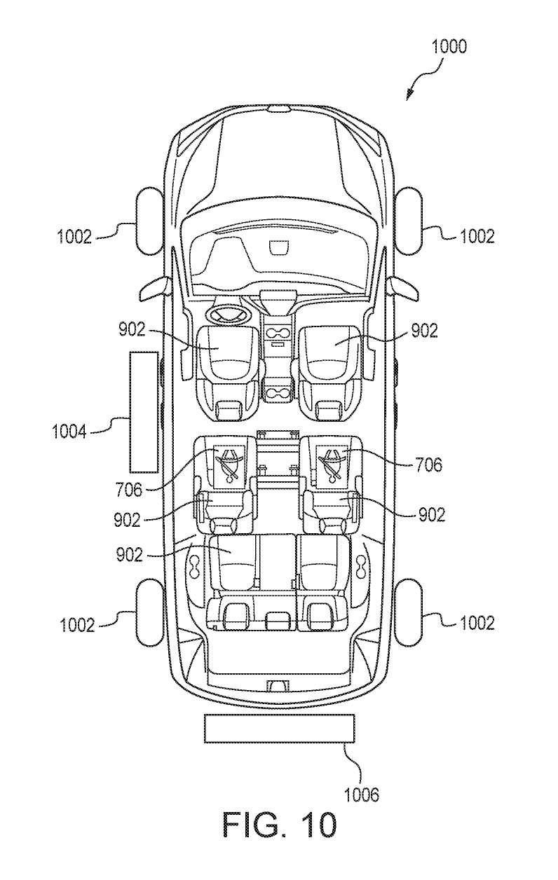

The vehicle 100 may include either a dedicated meter 900 in the vehicle 100 for displaying the one of the plurality of positions 902 of the seats 106, 108, 112, 114, 116 and providing “seatbelt unlatched” warnings 706 for unlatched and occupied seats as illustrated in FIG. 9. Alternately, a shared display 1000 in the vehicle 100 for displaying the one of the plurality of positions 902 of the seats 106, 108, 112, 114, 116 and providing “seatbelt unlatched” warnings 706 for unlatched and occupied seats as illustrated in FIG. 10. The shared display 1000 may further provide warnings for other vehicle systems, such as low tire pressure 1002, door ajar or open 1004, tailgate open 1006, and the like. The embodiment of a dedicated meter 900 or the embodiment of a shared display 1000 may be located in the dashboard 708, schematically illustrated in FIG. 7, or alternatively on a screen in a center console (not illustrated).

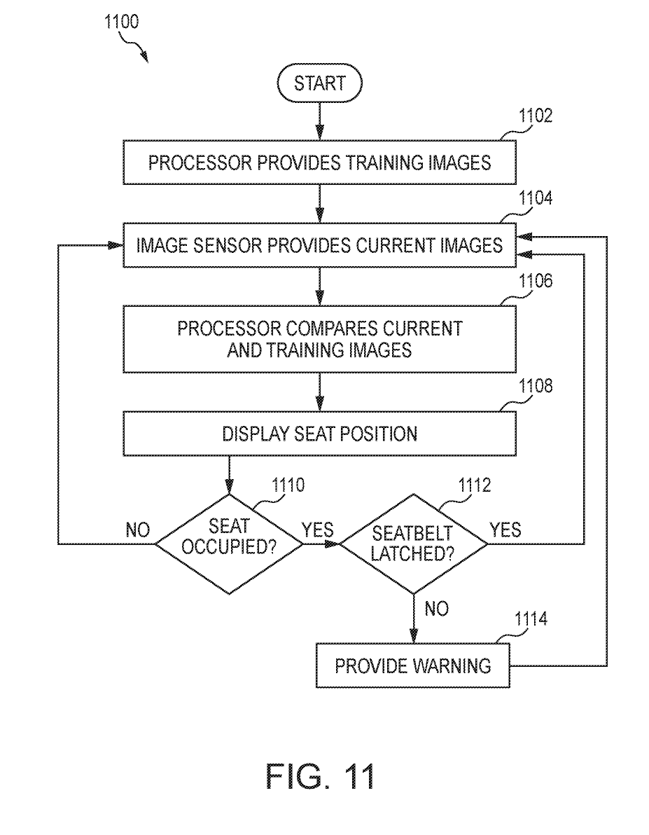

A method 1100 of detecting seatbelt position in a vehicle having a seat is illustrated in FIG. 11. The first step 1102 is employing the image sensor 600 to provide a plurality of training images of the seats 106, 108, 112, 114, 116 in a plurality of positions in the vehicle 100. The training images, each associated with a specific location of one of the seats 106, 108, 112, 114, 116, allow the processor 700 to have baseline images against which to compare further images to determine seat position. The second step 1104 is employing the image sensor 600 to provide a current, real-time image of the seats 106, 108, 112, 114, 116 in the vehicle 100. In the third step 1106, the current, real-time image is compared to the plurality of training images in the processor 700 to identify the position of the seats 106, 108, 112, 114, 116 in the vehicle 100. In an additional fourth step 1108, the position of the seats 106, 108, 112, 114, 116 in the vehicle 100 is provided to the display 704 for display to the operator of the vehicle 100.

As previously indicated, the position of the seats 106, 108, 112, 114, 116 may be communicated to a dedicated meter 900 in the vehicle 100 over a bus 702, a wired connection, or by any other suitable method known to those skilled in the art, for display to the operator, or the position of the seats 106, 108, 112, 114, 116 may be communicated to a shared display 1000 in the vehicle 100.

The third step 1106 of comparing the current, real-time image to training images may work by the processor 700 identify the webbing of the seatbelt assembly 506 to identify the position of the seats 106, 108, 112, 114, 116 in the current image. Alternatively, the processor 700 may identify a headrest 512, an armrest 510, or any other identifying marker to identify the position of the seats 106, 108, 112, 114, 116 in the current image.

Additionally, the method 1100 may further include the step 1110 of determining if the seats 106, 108, 112, 114, 116 are occupied or unoccupied using an occupancy sensor 800, and the additional step 1112 of determining if the seatbelt assembly 506 is in a latched or an unlatched condition using a latch sensor to determine if the status of latch 508. Therefore, when the current position of the seats 106, 108, 112, 114, 116 is communicated to the display 704, the display 704 may further be directed, in a final step 1114, to display a warning 706 to the operator or user of the vehicle 100 if one of the seats 106, 108, 112, 114, 116 is occupied and the seatbelt assembly 506 is unlatched, with the warning 706 illustrating the location of the one of the seats 106, 108, 112, 114, 116 that is causing the warning 706.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method of detecting seatbelt position in a vehicle having a seat, a seatbelt assembly, and an image sensor, the method comprising the steps of:
taking an image of the seat with the image sensor if the seatbelt assembly is unlatched;
determining a latch status of the seatbelt assembly as being latched or unlatched;
determining a position of the seat from the image; and
displaying the position of the seat on a display and a seatbelt unlatched warning to a user.

2. The method of claim 1 wherein the vehicle further has an occupancy sensor, first comprising the step of:
determining if a passenger is in the seat using the occupancy sensor.

3. The method of claim 1 wherein the step of displaying the position of the seat on a display and a seatbelt unlatched warning to a user further comprises the step of:
displaying the position of the seat on a dedicated meter in the vehicle.

4. The method of claim 1 wherein the step of displaying the position of the seat on a display and a seatbelt unlatched warning to a user further comprises the step of:
displaying the position of the seat on a shared display in the vehicle.

5. A seat belt latch alert system for a vehicle, comprising:
a first row of seats;
a seat located in a second row of seats, the seat movable between a plurality of positions;
a seatbelt assembly connected to the seat, the seatbelt assembly having a latch configured to be latched and unlatched;
an image sensor, the image sensor taking an image of the seat if the latch is unlatched;
a processor for determining a position of the seat from the image; and
a display for displaying the one of the plurality of positions of the seat and a seatbelt unlatched warning to a user.

6. The seat belt latch alert system of claim 5 further comprising:
an occupancy sensor for determining if a passenger is in the seat.

7. The seat belt latch alert system of claim 5 further comprising:
a dedicated meter in the vehicle for displaying the one of the plurality of positions of the seat.

8. The seat belt latch alert system of claim 5 further comprising:
a shared display in the vehicle for displaying the one of the plurality of positions of the seat.

9. The seat belt latch alert system of claim 5 wherein the processor is configured to determine the one of the plurality of positions of the seat from the image.

10. The seat belt latch alert system of claim 9 wherein the processor is configured to detect the seat belt assembly to identify the one of the plurality of positions of the seat.

11. A method of detecting seatbelt position in a vehicle having a seat, a seatbelt assembly connected to the seat, the seatbelt assembly including a webbing, an image sensor, a processor, and a display, the method comprising the steps of:
employing the image sensor to provide a plurality of training images of the seat in a plurality of positions in the vehicle;
employing the image sensor to provide an image of a position of the seat in the vehicle; and
comparing the image to the plurality of training images in the processor to identify the position of the seat in the vehicle.

12. The method of claim 11 further comprising the step of:
providing the position of the seat in the vehicle to the display.

13. The method of claim 12 further comprising the step of:
providing the position of the seat to a dedicated meter in the vehicle.

14. The method of claim 12 further comprising the step of:
providing the position of the seat to a shared display in the vehicle.

15. The method of claim 12 wherein the step of comparing the image to the plurality of training images further comprises the step of:
identifying the webbing of the seatbelt assembly to identify the position of the seat in the image.

16. The method of claim 12 wherein the step of comparing the image to the plurality of training images further comprises the step of:
identifying a headrest of the seat to identify the position of the seat in the image.

17. The method of claim 12 wherein the step of comparing the image to the plurality of training images further comprises the step of:
identifying an armrest of the seat to identify the position of the seat in the image.

18. The method of claim 12 wherein the step of comparing the image to the plurality of training images further comprises the step of:
identifying a marker on the seat to identify the position of the seat in the image.

19. The method of claim 12 further comprising the steps of:
determining if the seat is occupied or unoccupied using an occupancy sensor; and
determining if the seatbelt assembly is in a latched or an unlatched condition of the seat is occupied using a latch sensor.

20. The method of claim 19 further comprising the step of:
displaying a warning to a user of the vehicle if the seat is occupied and the seatbelt assembly is unlatched, the warning illustrating the location of the seat.
